(19) United States
(12) Patent Application Publication
(10) Pub. No.: US 2012/0006275 A1
(43) Pub. Date: Jan. 12, 2012

(54) KindCat Tidy Box

(76) Inventor: Karen Brenner, Westwood, MA (US)

(21) Appl. No.: 12/819,099

(22) Filed: Jul. 8, 2010

(51) Int. Cl. A01K 29/00

(52) U.S. Cl. 119/169

(57) ABSTRACT

A box for cat elimination use that simplifies clean-up, features only eco-friendly components, and is not expensive. The design includes 3 parts: box, trays and pad. The 12×18 wax coated cardboard box is sturdy and long lasting, and with proper use may not need replacing indefinitely. The waxed lift-out tray is a single design with handles on each short end, and is used on 2 levels inside the box: the lower lift-out tray (#1) is used to hold a reusable, washable, absorbent, compostable wool pad; the upper tray (#2) provides the animal's usage surface. The trays feature paw print-shaped die cuts, which allow excess fluid to flow from the top tray to the pad below. The trays are interchangeable; the bottom tray is used solely for the purpose of transporting the soiled pad from the box to the washing machine. The box should be used with paper-based litters, and may used with no litter if desired, once the animal learns to use the system.

The Tidy Box by KindCat is a waxed cardboard litter box system, which offers the eco-conscious cat owner the desirable features of product biodegradability, less litter use and simple clean-up. FIG. 1 of attached drawings shows the box prior to assembly. FIG. 2 shows the box in the assembled form, as it is when purchased. The box is a sturdy, 12×18″ wax-saturated, heavyweight, corrugated cardboard floor with 4″ high double-thick cardboard sides and ends. The tray component of the system is constructed of identical materials, and includes two side panels with cut-out handles that turn upward at the fold line where the end panels meet the floor of the tray. The tray is used as the elimination platform by the animal, with little to no litter needed, and its 20 paw-print shaped die cuts, which measure approximately 1.5″ each in diameter, allow for urine to pass from the top tray to the absorbent pad below. The tray handles permit the user to lift the tray out of the box to remove feces, which will roll off of the tray into the trash or toilet. A one inch high flap along each side of the tray prevents stools from falling off the tray while being discarded. If the cat has soft or wet stools, they may be wiped or sprayed off of the tray, as the waxed coating creates a smooth, stick-resistant surface. A 12×18″ machine washable, reusable and biodegradable pad, consisting of an absorbent woven fabric housed in an absorbent cloth bag, rests below the tray, and may sit on a second, bottom tray, or directly on the floor of the box. The end user may substitute the cloth pad with a different type of absorbent pad, or may place paper-based litter in the bottom chamber. The cat is encouraged to use the system by placing a small amount of litter on the top tray.

### DRAWINGS

FIG. 1 shows the unassembled box. It is a one piece wax saturated corrugated cardboard measuring 28×34″ with perforated fold lines at 4″ and 8″ inward from the border of all four sides, and 2 evenly spaced tab extensions along the border of each long side, and 1 tab extension centered along the border of each end. With the box flat, first fold the 2 long sides upward from the center floor panel along the innermost perforated fold line (FIG. 1A), then bend the end flaps of each side (FIG. 1B) inward to form 4 corners. Second, fold the 2 shorter end panels upward at the innermost perforated fold lines (FIG. 1C), then fold downward at the outermost fold line (FIG. 1D) toward the box floor, pressing tabs on the end flap (FIG. 1E) into corresponding impressions in the box floor along the 2 ends (FIG. 1F). Third, fold the two side panels downward toward the floor of the box at the outermost fold line (FIG. 1G), pressing the tabs on each side (FIG. 1H) into the impressions on the box floor (FIG. 1I) These shallow impressions do not cut through the floor of the box, so the box will not leak fluid content.

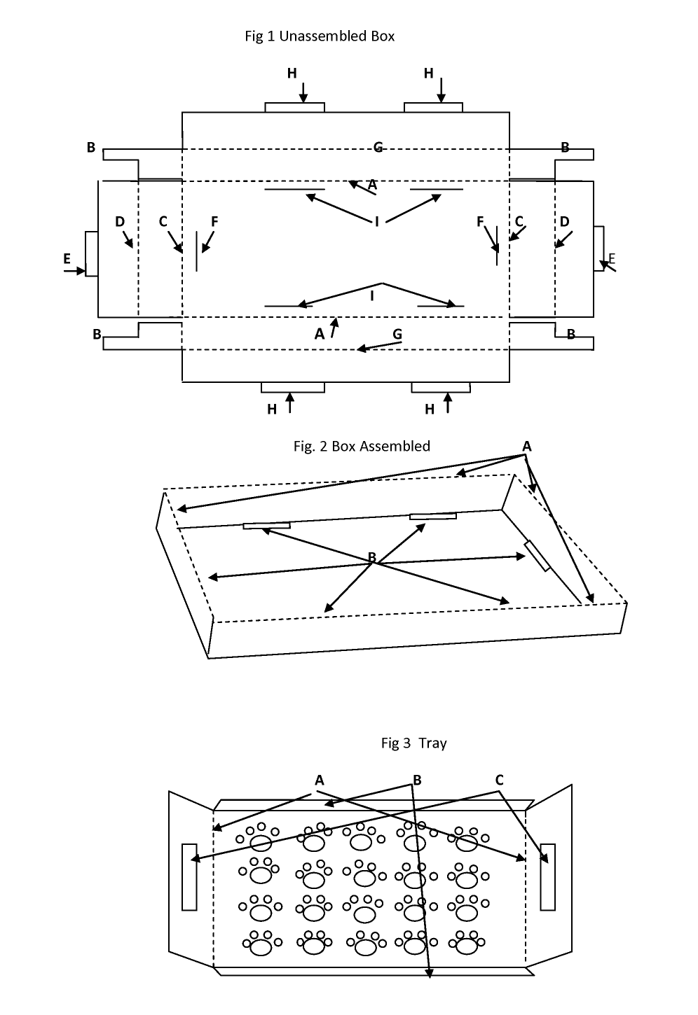

The tray (FIG. 3) is a 14×26″ one piece waxed corrugated cardboard unit with 20 die cuts centered in the inner 12×18 panel, two fold lines located 4 inches in from each short end, and two fold lines located 1 inch in from each long side. Assemble the tray by laying the piece flat and folding upward at the two fold lines (FIG. 3A) to created two handles that stand perpendicular to the tray floor, and folding upward the 1″ lip on each side of the tray (FIG. 3B). The tray is placed inside the assembled box. The handles are 4″ high along each end of the tray and feature a 1×4″ center cut-out into each end flap flat, which allows the user to place hands in the cut out and lift the tray (FIG. 3C). The surface of the tray includes 20 die cut paw print shaped cut-out, which are unique from other “screen” tray litter box inserts that have been designed to separate liquid and solids in cat boxes. Screen trays can be difficult to clean when they become blocked with wet or drying fecal matter, or even litters. The die cut holes in the paw print tray are small enough to stop feces from falling though, and large enough to resist blockage and let urine flow through to the pad below. The smooth waxy surface of the tray both repels liquids, helping the urine to flow toward the cuts in the surface, and solids, which slide easily from the tray into the appropriate receptacle. The box and trays kit is fully assembled when purchased, and comes with replacement trays and pads. The pad lasts through many washings, and at the termination of its usefulness may then be used for cat bedding, or donated to a cat shelter as such.

1. While other litter box inventions, past and present, have featured various tray and pad systems which separate fluid from solid waste, the KindCat Tidy Box claims the unique feature of a lift-out tray (FIG. 3). This lift-out tray has dual utility in that it serves to accomplish said waste separation, with the added benefit of simplifying the transport of solid waste to either toilet or trash, thereby eliminating the need for a litter scoop (which ultimately becomes soiled and requires cleaning), or any other type of litter sifting process to remove stools. A second claim of unique utility is the featured reusable, washable pad (not shown), which is unlike disposable pads that are used in other tray and pad systems. This pad is rectangular to fit exactly in the bottom of the box, or may be placed on a bottom tray if desired. It measures 12×17.75×¼ inches and is composed of biodegradable, natural wool material, and is housed in a natural cotton sack of the same dimensions, and with a drawstring which allows the user to move the pad without touching the damp material. The pad's utility continues indefinitely if it is retired as pet bedding, once it has broken down sufficiently as to be no longer useful as an absorbent pad. A third claim of unique utility is the advantage that the KindCat Tidy Box may be fully functional with little to no litter involved, once the cat adapts to using the system. The Tidy Box was designed in response to a need for a simple to clean cat box system that would be safe for the environment. Traditional litter boxes are mostly constructed of plastic, and some disposable and biodegradable models are available in cardboard and composite paper material. Kitty's WonderBox, Inc., for example, offers a biodegradable litter box, but it is for use with litter, and includes neither tray nor pad to facilitate clean-up. Several models of disposable “complete” litter box units are available, some in plastic with disposable liners, and others in a cardboard container, and all come with litter, but no tray, nor pad, and are for short-term use only until the litter is ready for disposal. There are a multitude of creative litter box options, ranging from simple containers to sophisticated electric self-cleaning models, to actual toilet-like designs that “flush” away litter with chemical cleaners. The Tidy Box is unique from these designs, in its simplicity and ecological compatibility, while combining low cost components and the opportunity to reduce litter use.
